(19) United States
(12) Patent Application Publication
(10) Pub. No.: US 2004/0010448 A1
(43) Pub. Date: Jan. 15, 2004

(54) System and method for marketing advertising space on disposable consumer items

(76) Inventor: William E. Miller III, Norfolk, VA (US)

Correspondence Address: J. Michael Martinez de Andino, Esq., HUNTON & WILLIAMS, Riverfront Plaza, East Tower, 951 East Byrd Street, Richmond, VA, 23219-4074, US

(21) Appl. No.: 10/607,357

(22) Filed: Jun. 26, 2003

Related U.S. Application Data
(60) Provisional application No. 60/395,463, filed on Jul. 12, 2002.

(51) Int. Cl. G06F 17/60

(52) U.S. Cl. 705/14

(57) ABSTRACT

A method is provided for marketing advertising space on a vendor-ordered disposable consumer item to which advertising indicia may be applied. The method comprises receiving a vendor order from a vendor, the vendor order including order information indicating type and quantity of disposable consumer item being ordered and at least one vendor usage parameter. The method further comprises soliciting at least one advertiser for advertising offers for placement of advertising indicia for placement on the disposable consumer item and receiving at least one advertising offer from an associated advertiser for placement of advertising indicia on the disposable consumer item. The method still further comprises selecting an acceptable advertising offer from the at least one advertising offer, producing the disposable consumer item with advertising indicia associated with the acceptable advertising offer disposed thereon and delivering the disposable consumer item to the vendor.

### FIELD OF THE INVENTION

The invention relates generally to the marketing of advertising space and more particularly to an automated system for marketing advertising space on disposable consumer items to lower the cost to a vendor procuring the disposable consumer items.

### BACKGROUND OF THE INVENTION

In today's economy, advertisers are constantly looking for new ways of presenting their messages and for new forums in which to present them. One forum that, heretofore, has remained largely untapped is the space provided on throw away containers such as coffee and beverage cups and on other disposable consumer items such as napkins, sugar packets, condiment packages, etc.

The potential reach of advertising on only a single type of disposable consumer item is significant. For example, in 1999 it was estimated by the Specialty Coffee Association of America that approximately 18.4 million one-time use, away-from-home consumption coffee cups were sold daily by coffee vendors in the United States alone. These cups are generally provided either with no advertising or logo at all or with only the advertising or logo of the coffee vendor (e.g., Starbucks® or 7-Eleven®) or the cup manufacturer.

Space on coffee or soda cups, as well as space on other disposable items supplied to consumers by food and beverage vendors, could just as easily be used for advertising the goods and services of third parties that are unrelated to the vendors or to the manufacturer of the disposable items. This advertising market has remained untapped, however, largely because of the inability of advertisers to connect with those vendors whose market coincides with the advertisers' target markets and who, at the same time, are willing to accept third party advertising on their goods.

Accordingly, there is a need for an advertising marketing system that coordinates the production of disposable consumer items needed by various vendors with a plurality of advertisers seeking exposure to the consumer population. In addition, there is a need for an efficient method for coordinating vendors of disposable consumer items with advertisers that results in a mutually beneficial relationship whereby vendors receive products at a lower cost based on the sale of advertising space on the disposable consumer items ordered.

### SUMMARY OF THE INVENTION

An illustrative embodiment of the invention provides a method for marketing advertising space on a vendor-ordered disposable consumer item to which advertising indicia may be applied. The method comprises receiving a vendor order from a vendor, the vendor order including order information indicating type and quantity of disposable consumer item being ordered and at least one vendor usage parameter. The method further comprises soliciting at least one advertiser for advertising offers for placement of advertising indicia for placement on the disposable consumer item and receiving at least one advertising offer from an associated advertiser for placement of advertising indicia on the disposable consumer item. The method still further comprises selecting an acceptable advertising offer from the at least one advertising offer, producing the disposable consumer item with advertising indicia associated with the acceptable advertising offer disposed thereon and delivering the disposable consumer item to the vendor.

Another illustrative embodiment of the invention provides a method for marketing advertising space on a vendor-ordered disposable consumer item to which advertising indicia may be applied using an advertising broker processing system. The advertising broker processing system is in an advertising marketing network having at least one vendor processing system, at least one advertiser processing system and at least one manufacturer processing system, each selectively in communication with the advertising broker processing system. The method comprises receiving at the vendor processing system a vendor order from one of the at least one vendor processing system, the vendor order including order information indicating type and quantity of disposable consumer item being ordered and at least one vendor usage parameter. The method further comprises transmitting from the advertising broker processing system to an advertiser group a solicitation communication including at least a portion of the order information and a solicitation of advertising offers for placement of advertising indicia on the disposable consumer item, the advertiser group including at least one of the at least one advertiser processing systems. The method still further comprises receiving at the advertising broker processing system at least one advertising offer from an associated advertiser processing system for placement of advertising indicia on the disposable consumer item, each of the at least one advertising offer including advertiser and advertising indicia information. The method also comprises processing at the advertising broker processing system the advertiser and advertising indicia information from each of the at least one advertising offer to determine an acceptable advertising offer and transmitting a manufacturing order to a selected one of the at least one manufacturer processing system. The manufacturing order provides for the manufacturing of the disposable consumer item with the advertising indicia associated with the acceptable advertising offer disposed thereon. The selected one of the at least one manufacturer processing system is associated with a selected manufacturer.

Yet another illustrative embodiment of the invention provides an advertising broker processing system for use in an advertising marketing system including at least one vendor processing system, at least one advertiser processing system and at least one manufacturer processing system, The advertising broker processing system comprises a communication module configured and adapted for communication with the vendor, advertiser and manufacturer processing systems through a network. The advertising broker processing system also comprises a transaction processing module configured and adapted for processing a vendor order received from a vendor processing system via the communication module. The transaction processing module is also configured and adapted for transmitting an advertising solicitation communication to the at least one advertiser processing system via the communication module, receiving advertising offers from the at least one advertising processing system via the communication module, selecting an acceptable advertising offer and transmitting a manufacturing order to one of the at least one manufacturing processing systems via the communication module. The vendor order includes a request for a consumer item on which advertising indicia may be disposed and the advertising offers each relate to placement of advertising indicia on the ordered consumer items.

### BRIEF DESCRIPTION OF THE DRAWINGS

The present invention can be more fully understood by reading the following detailed description of the embodiments together with the accompanying drawings, in which like reference indicators are used to designate like elements, and in which:

FIG. 1 is a flowchart showing a method for marketing advertising space on a vendor-ordered disposable consumer item in accordance with an embodiment of the invention;

FIG. 2 is a block diagram showing an advertising marketing system in accordance with an embodiment of the invention;

FIG. 3 is a block diagram showing an advertising broker processing system in accordance with an embodiment of the invention; and

FIG. 4 is a flowchart showing a method for marketing advertising space on a vendor-ordered disposable consumer item in accordance with an embodiment of the invention.

### DETAILED DESCRIPTION OF THE INVENTION

Further details of the systems and methods of the invention will hereinafter be described. As used herein, items referred to in the singular may also be in the plural, and items referred to in the plural may also be in the singular.

As used herein, “disposable consumer item” may describe cups, plates, bowls, flatware (i.e., knives, forks, spoons), napkins, food containers, condiment packages, straws, or other disposable consumer products related to the food and beverage industry, for example. Each disposable consumer item has at least one advertising portion for the placement of advertising indicia. An advertising portion may be any surface of the disposable consumer item that can have advertising indicia placed on it (i.e., on the outside of a coffee cup, the face of a napkin, etc.).

As used herein, a “processing system” or “system” may be a computer or network operating system that performs computational functions. The computational functions may be performed utilizing a suitable processor and memory stores, i.e. a data memory storage device, for example. The computational functions may include processing input and information from users (i.e., administrators, vendors, advertisers, manufacturers) of the system to perform its functions and applications; utilizing input and information from users and other systems, as well as other data in the memory stores of the system, to generate output on various interfaces with users; or outputting input or information gathered or produced by the system to other systems.

The present invention involves the use of networked processing systems to form an advertising marketing system. This system links vendors of disposable consumer items with advertisers who wish to place advertising on such items and with manufacturers who can provide such items to the vendors with the advertising displayed thereon. In this system, each potential participant (i.e., vendors, advertisers and manufacturers) can communicate with a advertising broker through their own processing systems. The advertising broker also has a processing system, which is used to match vendors, advertisers and manufacturers in accordance with methods described hereafter.

The processing systems used in implementing the invention and, in particular, advertising broker processing system, may manage a relational database of information while also allowing access to the advertising marketing system and the various applications and user interfaces available to the different participants (i.e., administrators, vendors, advertisers or manufacturers). A relational database system allows information contained in different tables to be accessed and shared, while also providing the additional advantage that changes to data contained in one table of a relational database affects the same data in any other table sharing the same data. For example, a table is a collection of several data records with similar data information fields. Data records represent a collection of data that is organized into fields. These fields may also be formatted to receive data of varying types. Accordingly, the database user can view data records in a user interface, input or edit the data contained in the various fields, or issue a database query that retrieves and reports information from multiple tables. Illustratively, when a vendor submits a request order to the advertising marketing system, the order may be stored in a record for association with potential advertisers that may want to place advertising on the items ordered by the vendor. Previously stored information associated with the particular vendor, such as prior request orders and the advertisers used, will be available to the advertising marketing system to assist in matching the vendor with a sponsoring advertiser.

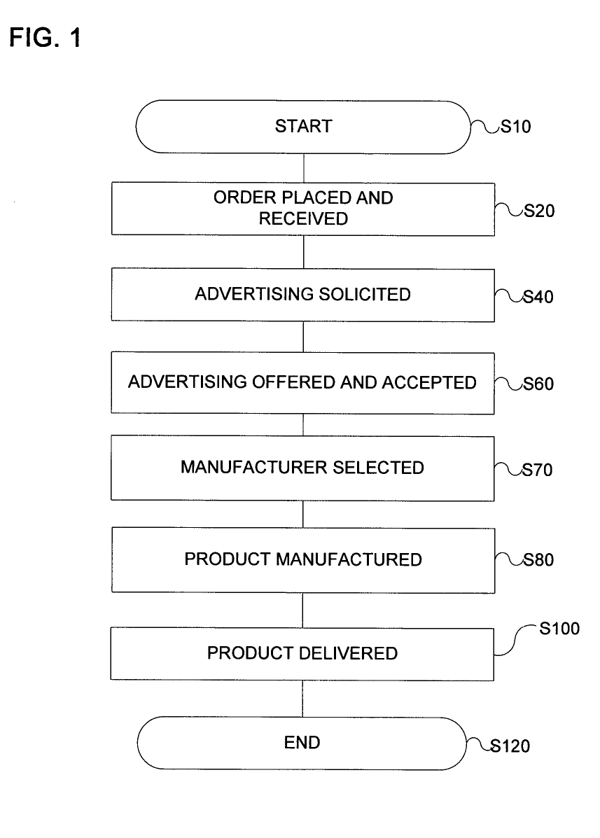

An illustrative flowchart showing a method for marketing advertising space on vendor-ordered disposable consumer items according to an embodiment of the invention is shown in FIG. 1. The process begins in step S10. At step S20, an order for a disposable consumer item is placed by a vendor and is received by the advertising broker. The vendor order indicates a disposable consumer item having at least one advertising portion and vendor usage parameters for the disposable consumer item. The vendor order can be submitted in any suitable manner that allows the vendor to provide input to the advertising marketing system. As will be discussed in more detail, the vendor may communicate with the advertising broker through a processing system linked to a advertising broker processing system through a network. Any communication link established between the vendor processor and the advertising broker system may be used.

For example, the vendor may use a vendor processing system to establish a connection to the Internet where a web page associated with the advertising marketing system may be accessed. Once the vendor's browser presents the web page, the vendor would be presented with a page that allows the vendor to provide certain identification information prior to making a vendor order for disposable consumer items. Such identification information may first include identifying the user as a vendor, and detailed information such as vendor name, vendor address, vendor account number (for prior users that have set up an account), vendor telephone number, public telephone directory listing, other information that identifies the individual vendor, or any combination thereof. The vendor may also be required to provide some type of authentication input, such as a password or pin number.

Before a vendor order may be placed, the vendor may be required to provide information (vendor usage parameters) related to its usage or consumption of disposable consumer items. For orders of coffee cups, for example, the vendor may be required to provide the total number of coffee cups sold per month at the vendor's business, the various sizes of coffee cups offered and the percentage of sales attributed to each size, or the length of time the vendor has been operating at the specified location. This information may be necessary to confirm the identity of the vendor and its business operations. Finally, the vendor may be required to accept certain terms and conditions for ordering of the disposable consumer items.

The vendor usage parameters provide detailed information about the vendor's planned usage for the disposable consumer items so that a potential advertiser can make an informed decision about whether or not sponsoring the advertising would be worthwhile. The vendor usage parameters may include the vendor's type of business, location, consumer audience, detailed sales analyses, units sold over time, or supply contracts with exclusive suppliers (i.e., vendor sells only Coke® products, as opposed to only Pepsi® products), for example.

It should be appreciated that upon accessing the advertising marketing system through the Internet, the user may be presented with a webpage that requires the user to choose between multiple applications offered by the system. Vendors seeking to place an order may be required to identify themselves as such, and would be prompted with an appropriate user interface for providing the information described above. Other system participants, such as potential advertisers or advertisers seeking to make an offer for a particular vendor order could similarly identify themselves and be prompted in accordance with instructions or information pertinent to their role in the advertising marketing system. In the case of an advertiser, this could include a user interface for providing an advertising order or submitting future information to the advertiser database. Administrators and manufacturers may access the system in a similar manner.

Returning to FIG. 1, once the vendor order has been received by the advertising broker, the process passes to step S40, wherein the advertising broker solicits one or more advertisers for the advertising portion of the disposable consumer item. The advertising broker may accomplish this by communicating the availability of the advertising space to advertisers over an advertiser network. The advertiser network includes at least one advertiser processing system and may include any number of additional advertiser processing systems. The advertiser network may comprise the processing systems of each advertiser identified in the advertising broker processing system's database of potential advertisers.

The communication format used to solicit advertising from the advertisers may take any of a variety of forms, including but not limited to sending targeted e-mails to multiple advertisers maintained in the advertiser database and posting information describing the vendor order over the Internet, where it can be viewed by numerous advertisers accessing the advertising marketing system. In the latter case, a brief alert e-mail may be delivered to potential advertisers notifying them of the vendor's request so that they may decide to visit the advertising marketing system's website for further information. The solicitation communication, whether accomplished by e-mail, Internet posting or other network means, identifies the vendor usage parameters described in the vendor order. The solicitation communication may also describe a minimum price for advertising associated with each disposable consumer item (e.g., for an order of 10,000 coffee cups, the minimum advertising cost could be $0.05 per cup). The communication may also establish a reserve price set at an amount that, if offered by advertiser, automatically closes the solicitation and awards the order to the offering advertiser.

Then, in step S60, an advertising offer is received from one or more advertisers. Similar to the vendor order, the advertising offer may be sent and received in any suitable manner that allows the advertiser to provide input to the advertising marketing system. Any communication link established between the advertiser and the advertising broker may be used. For example, the advertiser may use an advertiser processing system to establish a connection to the Internet where she can view a web page associated with the advertising marketing system. The advertising offer may include such information as the advertising indicia, or message, the price the advertiser is willing to pay to have the advertising indicia placed on each disposable consumer item in the vendor order (i.e., a price bid), advertiser account i.d., and terms and conditions (collectively, advertiser and advertising indicia information), for example. The advertising indicia may be requested in any form suitable to the advertiser to convey the advertising message and to the available processing space on the item ordered by the vendor.

The system may be adapted to allow prospective advertisers to provide their information and receive notification of future vendor orders that meet certain qualifications that have been defined. These advertisers may register to become a certified advertiser by agreeing to purchase disposable consumer items at a minimum cost, provide the advertising indicia they would like to use, and obtain a certified advertiser number. Using the certified advertiser number, advertisers can repeatedly access they system without having to provide all of their information with each offer, and can easily re-offer previously used or similar advertising material. Accordingly, the advertising broker processing system may be adapted to send notice to particular advertisers upon receiving a vendor order from vendors who are positioned in certain geographical regions, have a certain type of business or cater to a particular consumer demographic. Notice can be supplied to prospective advertisers by sending an electronic message to these advertisers' processing systems over the advertiser network.

If multiple advertising offers are received, the advertising broker may use any of various criteria to determine which advertiser's offer should be accepted. As previously indicated, under certain circumstances, the broker may accept the first offer meeting a minimum price per item. The advertising broker may, however, use the vendor usage parameters and advertiser/advertising indicia information to determine the best advertising fit for the vendor and the particular disposable consumer item ordered. Once the determination criteria are applied, an advertiser is selected and the advertiser's offer is accepted through an acceptance communication to the advertiser.

It should be appreciated that the solicitation for advertising over the advertiser network may utilize an iterative bidding process for selecting an advertising order that provides the most benefit to the administrators of the advertising marketing system. In essence, the advertising marketing system may receive multiple advertising orders from different advertisers for the same vendor order. In one embodiment, the system could set a time period for when the vendor order would be closed and notify each interested advertiser about the current highest offer (i.e., advertising price per consumer item) from an advertiser. Therefore, each interested advertiser would be aware of the current highest offer, and the remaining time left until the vendor order is closed. Notification of updated advertisers offers could be sent to all interested advertisers in any suitable manner, such as e-mail or by posting the vendor order results on a webpage associated with the advertising marketing system.

In an alternative approach to solicitation, the advertising broker or an administrator for the advertising marketing system may approach various advertisers that operate large national campaigns. For example, the administrator may target the advertising executives of a large national insurance company. Utilizing the advertising marketing system, the administrator can offer the insurance company the opportunity to have its advertising indicia, or message, placed on thousands of disposable consumer items. In this example, the advertising broker may have received a large vendor order for coffee cups sold nationwide in the vendor's chain of convenience stores. The advertising broker or administrator can offer the advertiser the opportunity to conduct a trial run that tests the effectiveness of advertising with the disposable consumer items. For example, the insurance company could order an advertisement that places an insurance offer with a distinct phone number on coffee cups in the hands of a specific audience (i.e., nationwide, by state, by locality, by zip code, by retail chain, by census tract, for example). Each week, the insurance company could measure the effectiveness of the coffee cup advertising by calculating the number of calls received on the distinct phone number. In this way, the advertising marketing system effectively matches the insurance company with the coffee cup vendor, fills the vendor's order for coffee cups, and satisfies the insurance company's advertising needs. If the trial period is successful for the insurance company, the advertising level can be increased. Similarly, the advertising broker may enter agreements with certain advertisers whereby the advertisers agrees to pay for advertising for all vendor orders for disposable consumer items in a specified region (i.e., nationwide, by state, by region, by locality, by zip code, by retail chain, by census tract, for example).

It should be appreciated that the process may include additional confirmation steps prior to ordering the disposable consumer items from a manufacturer. For example, the vendor may review the advertising order selected to fulfill the vendor order, and if necessary, void the order because the order would contradict some business objective of the vendor. Similarly, the advertiser may review a prototype disposable consumer item with the advertising indicia to determine if the finished product is worthwhile. In either case, the parties may determine that they no longer want to participate in the transaction. However, the advertising marketing system may include withdrawal penalties for any party that removes its consent to the advertising agreement formed, to ensure that the administrators of the advertising marketing system are not circumvented after providing the initial introduction for the transaction. In a further embodiment, users of the advertising marketing system my be charged a fee for accessing the system and taking advantage of its services. Such fees may be based on an amount of access or for unlimited access on a periodic basis (i.e., monthly billing).

Once an advertising offer has been accepted, a manufacturer is selected to produce the disposable consumer item, with the advertiser's advertising applied, at step S80. The manufacturer may be selected from a database of manufacturers for various type of disposable consumer items. The advertising broker may maintain a standing agreement with various manufacturers to produce particular items or, alternatively, may employ a solicitation and bidding approach similar to that discussed above for advertisers. The latter approach may be particularly suitable for less common consumer items or for unusually large or small orders. In either case, the method of the invention provides an efficient approach to manufacturing disposable consumer items at the lowest possible production costs.

It will be understood that while the above description involves a single manufacturer providing a product with advertising applied, the general method may be applied to products that require two or more manufacturers. For example, a first manufacturer could be a selected for manufacturing the product and a second to apply the advertising to the product.

Upon manufacturer selection, a firm order for disposable consumer items having the desired advertising thereon may be placed with the selected manufacturer who then manufactures the disposable consumer items at step S80.

At step S100, the disposable consumer item are delivered to the vendor. In most instances, the disposable consumer items are shipped directly to the vendor by the manufacturer. In some embodiments, the manufacturer can upload status information on the production and delivery of the disposable consumer items to the advertising marketing system where it can be accessed by the vendor.

The process ends at step S120.

It should be appreciated that the advertising broker serves as an administrator of the various transactions in the securing of the disposable consumer items for the vendor. The advertising broker may also monitor the performance of each step by the participants. In at least one embodiment of the invention, there is no provision or need for the participants in the advertising marketing system (i.e., the vendors, advertisers and manufacturers) to have any direct contact. The advertising broker coordinates the transactional relationships for filling each order and ensures performance by each participant in the process.

In some embodiments, the advertising broker provides a tracking feature whereby each participant in a particular transaction may access the advertising marketing system (i.e., logging onto an associated website, for example) to obtain status information on that transaction. Accordingly, each vendor, advertiser and manufacturer may be provided with a transaction identification number that can be submitted to the system, and which allows access to the important status information. Using the identification number, vendors can track whether an advertiser has submitted an offer for advertising on the disposable consumer items ordered by the vendor, or whether the manufacturer has completed production and when the vendor can expect delivery date. Similarly, advertisers can access information on the delivery of the disposable consumer items to the vendor and usage information supplied by the vendor. The advertising marketing system thus provides in the advertising broker, a single point of access whereby each participant in the transaction can obtain information relevant to their participation in the transaction, without having direct contact with other participants.

The advertising broker may receive advertising payments from the advertiser at the time the advertising offer is made or accepted. These payments may be used to pay for the production of the disposable consumer items and to have them delivered to the vendor. Payment amounts over and above these costs may be kept as profits by the advertising broker. Accordingly, the administrators of the advertising marketing system profit from achieving the highest possible advertising order (i.e., advertising price per disposable consumer item) with the lowest possible manufacturing costs (i.e., per disposable consumer item).

In an illustrative embodiment of the invention, an advertising marketing broker may offer online a series of applications wherein various users provide information that may be queried against related databases of other users information. The advertising broker processing system may include several databases of information that allow it to match vendors and vendor orders for disposable consumer items with potential advertisers that wish to place advertising on the ordered disposable consumer items. The revenues received for the advertising would, in effect, lower or eliminate the cost of the disposable consumer item to the vendor.

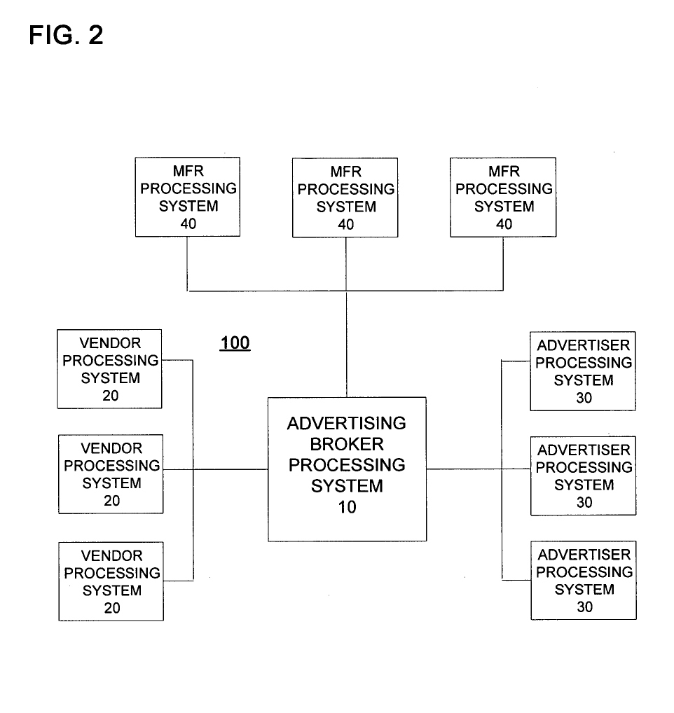

FIG. 2 illustrates a block diagram of an advertising marketing system 100 according to an embodiment of the invention. The advertising marketing system includes a advertising broker processing system 10 and one or more vendor processing systems 20, one or more advertiser processing systems 30 and one or more manufacturer processing systems 40. Each of the vendor, manufacturer and advertiser processing systems 20, 30, 40 may be selectively in communication with the advertising broker processing system 10 through a communication network. Any suitable communication network may be used including an Intranet, Extranet, LAN or WAN or the Internet.

While many of the examples provided herein describe access to the advertising marketing system 100 through the Internet, it will be understood that other access modes may be used depending on the type and configuration of the network. These include any suitable communication interface, Ethernet connection, modem, telephone, digital or analog connections with the system using wireless communication devices, token ring, Intranet or other computer connection, or any other suitable connection through which the advertising broker processing system 10 might receive input from an external source.

The processing systems 1, 20, 30 of the advertising marketing system 100 may be in the form of a computer or computer system. The term “computer system” or “operating system” is to be understood to include at least one processor utilizing a memory or memories. The memory stores at least portions of an executable program code at one time or another during operation of the processor. Additionally, the processor executes various instructions included in that executable program code. An executable program code means a program in machine language or other language that is able to run in a particular computer system environment to perform a particular task. The executable program code process data in response to commands by a user. As used herein, it will be appreciated that the term “executable program code” and term “software” mean substantially the same thing for the purposes of the description as used herein.

It should also be appreciated that to practice the system and method of the invention, it is not necessary that the processor, or subportions of the processor, and/or the memory, or subportions of the memory be physically located in the same place or disposed in the same physical portion of the advertising marketing system 100. Each of the processor and the memory may be located in geographically distinct locations and connected so as to communicate in any suitable manner, such as over a wireless communication path, for example. Each of the processor and/or the memory may also be composed of different physical pieces of equipment. It is not necessary that the processor be one single piece of equipment in one location and that the memory be another single piece of equipment in another location. The processor may be two pieces of equipment in two different physical locations connected in any suitable manner. Additionally, each respective portion of the memory described above may include two or more portions of memory in two or more physical locations, including or utilizing memory stores from the Internet, an Intranet, an Extranet, a LAN, a WAN or some other source or over some other network, as may be necessary or desired.

Furthermore, software enables the computer or network operating system to perform the operations described above and may be supplied on any of a wide variety of data holding media. The implementation and operation of the invention may be in the form of computer code written in any suitable programming language, which provide instructions to the computer. It should further be appreciated that the software code or programming language that is utilized in a computer system to perform the various operations of the above described invention may be provided in any of a wide variety of forms. Illustratively, the software may be provided in the form of machine language, assembly code, object code, source language, flash application or other program that is interpreted by a user's browser, as well as in other forms. The software may be in the form of compressed or encrypted data utilizing a known compression format or encryption algorithm.

Additionally, it should be appreciated that the particular software medium utilized may take on any of a variety of physical forms. Illustratively, the medium may be in the form of a compact disk, a DVD, an integrated circuit, a hard disk, a floppy diskette, a magnetic tape, a RAM, a ROM, or a remote transmission, as well as any other medium or source of information that may be read by a computer or other operating system.

Accordingly, the software of the method of the invention, which is utilized in operation of the advertising marketing system 100, and, in particular, the advertising broker processing system 10, may be provided in the form of a hard disk or be transmitted in some form using a direct wireless telephone connection, the Internet, an Intranet, or a satellite transmission, for example. Further, the programming language enabling the system and method of the invention as described above may be utilized on all of the foregoing and any other medium by which software or executable program code, such as a flash application, may be communicated to and utilized by a computer or other operating system.

As described herein, the system and method of the invention may utilize an application program, a collection of separate application programs, a subprogram of a program that is designed to handle an application, or a portion of a subprogram of a program, for example. As noted above, it should be appreciated that the computer language used in the system and method of the invention may be any of a wide variety of programming languages. Further, it is not necessary that a single programming language be utilized in conjunction with the operation of the system and method of the invention. Rather, any number of different programming languages may be utilized as is necessary or desirable.

The advertising marketing system 100 may be adapted to practice the previously described methods for brokering advertising for and filling vendor orders for disposable consumer items. Accordingly, the advertising marketing system 100 may include the processing systems of an unlimited number of potential vendor customers, advertisers and manufacturers, each able to communicate with the advertising broker processing system 10. The vendor processing systems 20, the advertiser processing systems 30 and the manufacturer processing systems 40 may generally be a personal computer or any other communication device usable to access the network for communication of data to and from the advertising broker processing system 10.

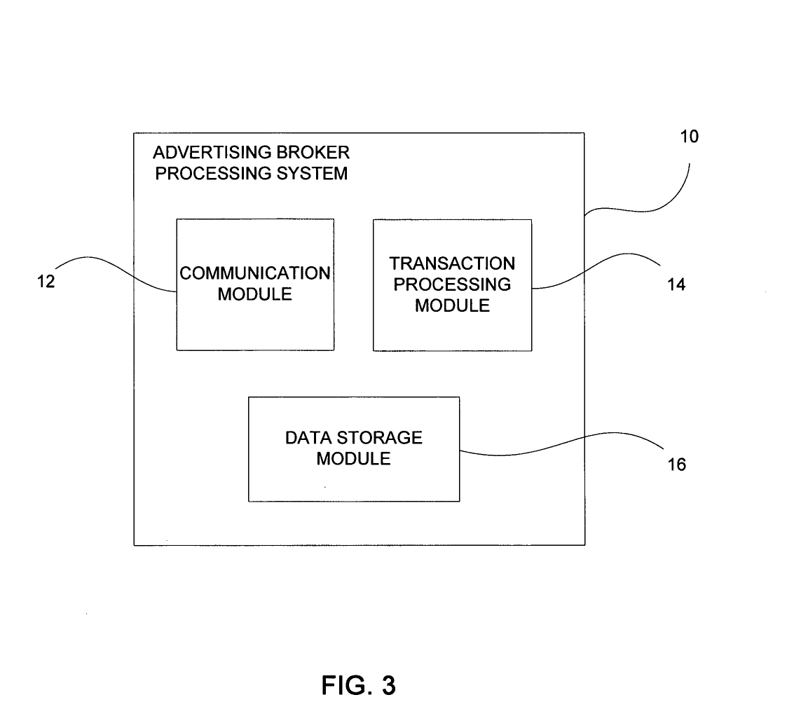

The advertising broker processing system 10 is adapted to communicate with the other processing systems of the advertising marketing system 100, store and selectively access information relating to transactions and the participants thereof and to process and monitor vendor order and advertising marketing transactions. With reference to FIG. 3, the advertising broker processing system 10 comprises a communication module 12, a transaction processing module 14 and a data storage module 16.

As used herein, the term “module” refers to any portion or collection of sub-portions of a computer processing system that may be configured or programmed to carry out one or more predetermined functions. A module may comprise one or more portions of hardware and software that may or may not be co-located.

The communication module 12 is configured and programmed for processing input from and generating output to the vendor processing systems 20, advertiser processing systems 30 and manufacturer processing systems 40. The user communication module 12 thus provides the interface through which the various system users can provide input to the advertising marketing system 100. The communication module 12 may comprise any user interface suitable for providing user interaction capabilities and may be controlled by the transaction processor module 14, or components thereof. The transaction processor module 14 may, for example, determine the appropriate graphics and information queries that should be sent to a user's display based on information received from the user through the communication module 12.

The system and method of the invention may use any of a variety of user interfaces. A user interface may be in the form of a web page or other interactive application presented on a user system by the user's browser, for example. The web page or application could include fields for accepting data and transmitting data to the advertising broker processing system 10 for storage. As used herein, a user interface includes any software, hardware or combination of hardware and software used in an operating system that allows a user to interact with the operating system. A user interface may include any of a touch screen, keyboard, mouse, or any other object that allows a user to receive information regarding the operation of the program and/or provide the operating system with information. Accordingly, the user interface is any device that provides communication between a user and a computer. The information provided by the user to the computer through the user interface may be in the form of a command, a selection or data, or other input, for example.

A user interface is utilized by an operating system running an application program to process data for a user. As should be appreciated, a user interface is typically used by a computer for interacting with a user either to convey information or receive information. However, it should be appreciated that in accordance with the system and method of the invention, it is not necessary that a human user actually interact with a user interface generated by the operating system of the invention. Rather, it is contemplated that the user interface of the invention interact, i.e., convey and receive information, in communication with another operating system or computer, rather than a human user. Further, it is contemplated that the user interfaces utilized in the system and method of the invention may interact partially with another operating system while also interacting partially with a human user.

The transaction processing module 14 monitors and controls the various operations of the advertising broker processing system 10. Initially, it processes the information provided by the various participants when accessing the advertising marketing system 100 and stores the information in the data storage module 16. This information may include all vendor, advertiser and manufacturer identification and supplementary information which may be used to track subsequent transactions and assure accurate billing and product delivery. The transaction processing module 14 is also adapted to process vendor orders received through the communication module 12, construct advertising solicitations for communication to advertisers through the communication module 12, process advertising offers received from advertisers through the communication module 12, and facilitate or automatically conduct the advertiser selection process. The transaction processing module 14 may similarly be adapted to identify appropriate manufacturers using information from the data storage module 16 or facilitate or conduct a manufacturer solicitation/selection process.

The data storage module 16 serves as a memory store for a wide variety of data used by the transaction processing module 14, as well as the other components of the advertising marketing system 100. For example, the data storage module 16 may contain the various databases of vendors and vendor order information, existing and potential advertisers and manufacturers.

It should be appreciated that the various memory components contained in the data storage module 16 may take on a variety of architectures as is necessary or desired by the particular operating circumstances. Further, the various memory components of the data storage module 16 may exchange data or utilize other memory component data utilizing known techniques such as relational database techniques.

The above-described databases may include information on the various users of the advertising marketing system, such as vendors that place orders, advertisers that have expressed an interest in sponsoring some advertising or that have done so in the past, as well as manufacturers that have produced the final product, i.e., the disposable consumer items with the advertising indicia in the advertising portion. The database information may include previous order records, containing information such as the type of disposable consumer items provided, the quantity, each participant's role in the transaction, the advertising indicia used, the associated costs and pricing, for example. For prospective users, the database may hold the user names, addresses, account numbers, phone numbers, as well as order information, usage data, and other valuable information about the user's desire to be matched with a vendor or advertiser.

The advertising broker processing system 10 may also have a system management module 18 that provides an interface between the system administrator, the advertising broker processing system 10, and the other processing systems 20, 30, 40. A system administrator mainly utilizes the management module 18 to manage the storage of data and information in the data storage module 16, as well as provide updates to the advertising marketing applications.

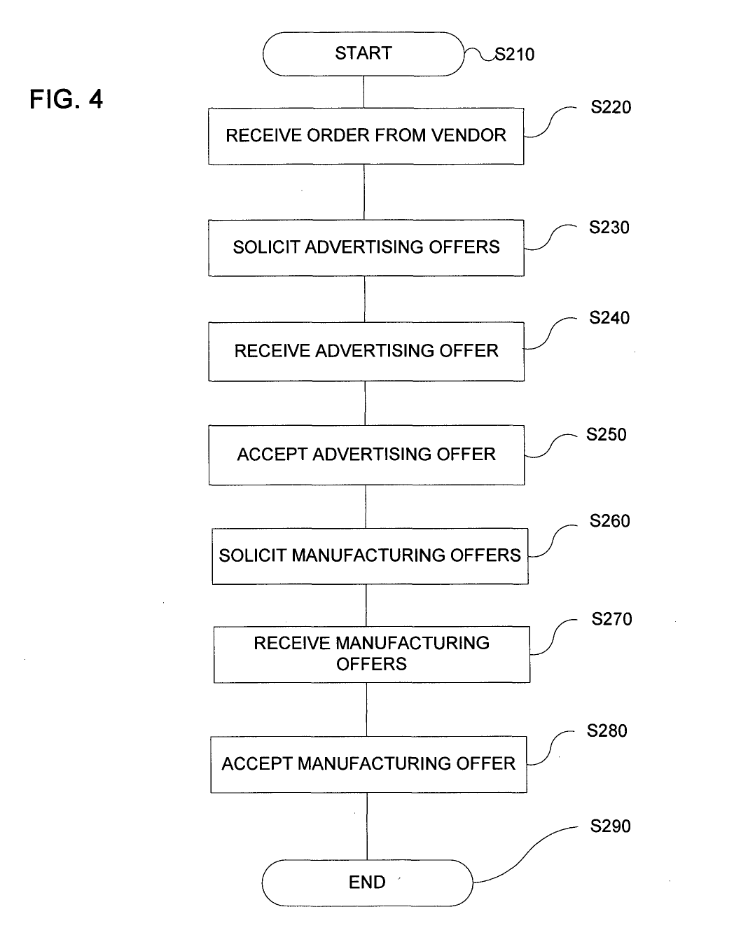

In an illustrative embodiment, the advertising broker processing system 10 may be used to carry out a method for conducting an advertising brokerage transaction as shown in the process flow diagram of FIG. 4. The method begins at step S210. At step S220, the advertising broker processing system 10 receives an order from a vendor. The vendor's order is received by the communication module 12 from a vendor processing system 20. The vendor may accomplish this by accessing the advertising broker processing system 10 through the network connection. When access is established, the advertising broker processing system 10 utilizes the communication module 12 to display a user interface to the vendor processing system 20 for placing a vendor order. The vendor enters information reflecting an order for disposable consumer items having one or more advertising portions along with vendor usage parameters for the disposable consumer items. This information is then received by the transaction processing module 14 through the communication module 12. The transaction processing module may process this data and/or store the data in the data storage module for later retrieval.

At step S230, the advertising broker processing system 10 may be used to facilitate or conduct the solicitation of advertising offers from advertisers. The transaction processing module 14 may be adapted for retrieving and using advertiser data stored in the data storage module along with vendor order information to identify potential advertisers. The transaction processing module 14 may be further adapted to transmit a solicitation communication to one or more advertiser processing systems 30 through the communication module 12. The one or more advertising processing systems 30 may collectively be referred to as an advertiser network. The solicitation communication may be in the form of directed e-mails or as messages posted to a network bulletin board or web site.

The advertiser processing systems 30 may be used by advertisers from different regions around the United States, or the world. In this respect, the advertising broker may compile information from the various advertiser processing systems 30 that have expressed an interest in sponsoring the supply of disposable consumer items with paid advertising. Accordingly, information provided by vendors can be utilized to associate a vendor with the various advertisers that may be willing to sponsor the ordered disposable consumer items based on the consumers expected to purchase the vendor's products. This allows the advertising broker to target solicitation communications to the advertisers most likely to be interested.

Solicitation communications would typically include vendor order information relevant to a decision on the part of the advertiser as to whether to offer to pay for placement of advertising on the disposable consumer items used to fill the vendor's order. In addition to identifying the type and quantity of items ordered, the communication may include various vendor usage parameters that would allow the advertiser to assess the market that will be reached by the disposable consumer items ordered.

At step S240, the advertising broker processing system 10 receives an advertising offer from at least one of the solicited advertisers. The transaction processing module 14 receives the offer through the communication module 12 and uses it to facilitate or conduct a selection of an advertiser. The selection process may involve comparison of offer information to selection criteria and vendor usage parameters to determine a good fit. Once a selection is made, the offer of the selected advertiser is accepted at step S250. This may be accomplished by any suitable communication to the advertiser, which may be transmitted to and received by the advertiser's processing system 30.

At step S260, the advertising broker processing system 10 may be used to facilitate or conduct the solicitation of manufacturing offers from manufacturers. This step may be carried out in a manner similar to that for soliciting advertisers. The transaction processing module 14 thus may be adapted for retrieving and using manufacturer data stored in the data storage module 16 along with vendor order information and the desired advertising to be placed on the ordered consumer items. The transaction processing module 14 may be further adapted to transmit a solicitation communication to one or more manufacturer processing systems 40 through the communication module 12. As before, the solicitation communication may be in the form of directed emails or as messages posted to a network bulletin board or web site. At least one manufacturing offer is received at step S270. The transaction processing module 14 processes this offer and uses it to facilitate a selection of a manufacturer. The manufacturing offer of the selected manufacturer is then accepted at step S280.

The selection of a manufacturer may involve retrieval of manufacturer characteristic information stored in the data storage module. This information may include manufacturer-provided information relating to the products manufactured by the manufacturer. The information may also include manufacturing production history, manufacturing capacity, order size limitations and other limitations that could assist in determining if a manufacturer is suitable for a particular vendor order. Such information is generally stored in the data storage module in a form that allows for easy comparison with manufacturing selection criteria.

As an alternative to steps S26, S270 and S280, the advertising broker may establish pre-transaction agreements with certain manufacturers such that solicitation and/or bidding is unnecessary. Under these circumstances, the transaction processing module 14 need only identify and notify the proper manufacturer for a particular vendor order.

In either case, the advertising broker processing system 10 may send an electronic order to the manufacturer processing system 40 of the manufacturer to have the ordered disposable consumer items produced. Each disposable consumer item may then be produced in accordance with the vendor and advertising orders, and agreed terms and conditions.

The method ends at step S290.

It will be understood that additional process steps may be included in methods carried out by the advertising broker processing system 10. In particular, the transaction processing module 16 may be adapted to monitor the status of the manufacturing of the vendor's disposable consumer items with the advertising of the selected advertiser properly incorporated. The transaction processing module 16 may also be adapted for tracking delivery of the vendor's items.

The transaction processing module 16 may also be adapted for billing the advertisers and, if necessary, the vendor, and for providing payment to the manufacturer.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

It will be understood that the present invention may be practiced by adding additional steps to the method, omitting steps within the process, and/or altering the order in which the steps are performed in the process.

Accordingly, while the present invention has been described here in detail in relation to its preferred embodiment, it is to be understood that this disclosure is only illustrative and exemplary of the present invention and is made merely for the purposes of providing a full and enabling disclosure of the invention. Many modifications to the embodiments described above can be made without departing from the spirit and scope of the invention. Accordingly, the foregoing disclosure is not intended to be construed or to limit the present invention or otherwise to exclude any other such embodiments, adaptations, variations, modifications and equivalent arrangements.

What is claimed is:

1. A method for marketing advertising space on a vendor-ordered disposable consumer item to which advertising indicia may be applied, the method comprising:
receiving a vendor order from a vendor, the vendor order including order information indicating type and quantity of disposable consumer item being ordered and at least one vendor usage parameter;
soliciting at least one advertiser for advertising offers for placement of advertising indicia on the disposable consumer item;
receiving at least one advertising offer from an associated advertiser for placement of advertising indicia on the disposable consumer item;
selecting an acceptable advertising offer from the at least one advertising offer;
producing the disposable consumer item with advertising indicia associated with the acceptable advertising offer disposed thereon; and
delivering the disposable consumer item to the vendor.

2. A method for marketing advertising space according to claim 1, further comprising:
accepting the acceptable advertising offer by notifying the associated advertiser.

3. A method for marketing advertising space according to claim 2 further comprising:
determining a set of advertiser selection criteria for use in selecting an acceptable advertising offer.

4. A method for marketing advertising space according to claim 3 wherein each advertising offer includes advertiser and advertising indicia information and the step of selecting an acceptable offer includes
comparing the advertiser and advertising indicia information to the set of advertiser selection criteria.

5. A method for marketing advertising space according to claim 4 wherein the advertiser and advertising indicia information includes a price bid.

6. A method for marketing advertising space according to claim 2 wherein the step of selecting an acceptable advertising offer is carried out at least in part by the vendor.

7. A method for marketing advertising space according to claim 1 further comprising:
receiving an advertising payment from the advertiser associated with the acceptable advertising offer.

8. A method for marketing advertising space according to claim 7 further comprising:
applying the advertising payment to manufacturing costs associated with producing the disposable consumer item.

9. A method for marketing advertising space according to claim 1 further comprising selecting a manufacturer and wherein the step of producing the disposable consumer item is carried out by the selected manufacturer.

10. A method for marketing advertising space according to claim 9, wherein the steps of receiving a vendor order, soliciting at least one advertiser, receiving at least one advertising offer, selecting an acceptable advertising offer and selecting a manufacturer are carried out by an advertising broker.

11. A method for marketing advertising space according to claim 10, wherein the steps of receiving a vendor order, soliciting at least one advertiser, receiving at least one advertising offer, selecting an acceptable advertising offer and selecting a manufacturer are carried out by an advertising broker processing system.

12. A method for marketing advertising space on a vendor-ordered disposable consumer item to which advertising indicia may be applied using an advertising broker processing system in an advertising marketing network having at least one vendor processing system, at least one advertiser processing system and at least one manufacturer processing system, each selectively in communication with the advertising broker processing system, the method comprising:
receiving at the vendor processing system a vendor order from one of the at least one vendor processing system, the vendor order including order information indicating type and quantity of disposable consumer item being ordered and at least one vendor usage parameter;
transmitting from the advertising broker processing system to an advertiser group a solicitation communication including at least a portion of the order information and a solicitation of advertising offers for placement of advertising indicia on the disposable consumer item, the advertiser group including at least one of the at least one advertiser processing systems;
receiving at the advertising broker processing system at least one advertising offer from an associated advertiser processing system for placement of advertising indicia on the disposable consumer item, each of the at least one advertising offer including advertiser and advertising indicia information;
processing at the advertising broker processing system the advertiser and advertising indicia information from each of the at least one advertising offer to determine an acceptable advertising offer;
transmitting a, manufacturing order to a selected one of the at least one manufacturer processing system for the disposable consumer item with advertising indicia associated with the acceptable advertising offer disposed thereon, the selected one of the at least one manufacturer processing system being associated with a selected manufacturer.

13. A method for marketing advertising space according to claim 12, further comprising:
establishing an advertiser database in the advertising broker processing system; and
storing in the advertiser database advertiser characteristic information including at least one of advertiser-provided interest information, advertiser account information, and advertising transaction history information.

14. A method for marketing advertising space according to claim 13, further comprising;
retrieving advertiser characteristic information from the advertiser database; and
determining the group of advertisers based at least in part on the advertiser characteristic information and the order information.

15. A method for marketing advertising space according to claim 12 wherein the step of processing the advertiser and advertising indicia information from each of the at least one advertising offer to determine an acceptable advertising offer includes:
determining a set of advertiser selection criteria for use in determining an acceptable advertising offer; and
comparing the advertiser and advertising indicia information of each of the at least one advertising offer to the set of advertiser selection criteria.

16. A method for marketing advertising space according to claim 4 wherein the advertiser and advertising indicia information includes a price bid.

17. A method for marketing advertising space according to claim 1 further comprising:
receiving an advertising payment from the advertiser processing system associated with the acceptable advertising offer.

18. A method for marketing advertising space according to claim 7 further comprising:
transmitting at least a portion of the advertising payment to the selected one of the at least one manufacturer processing system in payment for costs associated with the manufacturing order.

19. A method for marketing advertising space according to claim 12 further comprises:
establishing manufacturer database in the advertising broker processing system; and
storing in the manufacturer database manufacturer characteristic information including at least one of manufacturer-provided product information, manufacturer account information, and manufacturer production history information.

20. A method for marketing advertising space according to claim 19, further comprising:
retrieving manufacturer characteristic information from the manufacturer database; and
determining the selected manufacturer based at least in part on the manufacturer characteristic information, the order information and the advertiser and advertising indicia information of the acceptable advertising offer.

21. A method for marketing advertising space according to claim 19, further comprising:
transmitting from the advertising broker processing system to a manufacturer group a second solicitation communication including a solicitation of manufacturing offers for manufacturing the disposable consumer item, the manufacturer group including at least one of the at least one manufacturer processing systems;
receiving at the advertising broker processing system at least one manufacturing offer from an associated manufacturer processing system for manufacturing the disposable consumer item, each of the at least one manufacturing offer including disposable consumer item manufacturing information;
processing at the advertising broker processing system the disposable consumer item manufacturing information from each of the at least one manufacturing offer to determine an acceptable manufacturing offer and the selected manufacturer.

22. A method for marketing advertising space according to claim 21, further comprising:
retrieving manufacturer characteristic information from the manufacturer database; and
determining the group of manufacturers based at least in part on the manufacturer characteristic information, the order information and the advertiser and advertising indicia information of the acceptable advertising offer.

23. An advertising broker processing system for use in an advertising marketing system including at least one vendor processing system, at least one advertiser processing system and at least one manufacturer processing system, the advertising broker processing system comprising:
a communication module configured and adapted for communication with the vendor, advertiser and manufacturer processing systems through a network; and
a transaction processing module configured and adapted for processing a vendor order received from a vendor processing system via the communication module, transmitting an advertising solicitation communication to the at least one advertiser processing system via the communication module, receiving advertising offers from the at least one advertising processing system via the communication module, selecting an acceptable advertising offer and transmitting a manufacturing order to one of the at least one manufacturing processing systems via the communication module,
wherein the vendor order includes a request for a consumer item on which advertising indicia may be disposed and wherein the advertising offers each relate to placement of advertising indicia on the ordered consumer items.

24. An advertising broker processing system according to claim 23 further comprising:
a data storage module configured and adapted for selective storage of information associated with one or more of the group consisting of vendors associated with the at least one vendor processing system, advertisers associated with the at least one advertiser processing systems, manufacturers associated with the at least one manufacturer processing system, and previous transactions.
